(19) United States
(12) Patent Application Publication
(10) Pub. No.: US 2015/0287148 A1
(43) Pub. Date: Oct. 8, 2015

(54) MOBILE APPLICATION FOR VOLUNTEER SERVICE TRACKING, PROMOTION, AND PARTICIPATION

(71) Applicant: Lovell Corporation, Kitchener (CA)

(72) Inventor: Kelly Ann Lovell, Waterloo (CA)

(73) Assignee: Lovell Corporation

(21) Appl. No.: 14/677,880

(22) Filed: Apr. 2, 2015

Related U.S. Application Data
(60) Provisional application No. 61/973,931, filed on Apr. 2, 2014.

(51) Int. Cl. G06Q 50/00; G06Q 30/02

(52) U.S. Cl. CPC G06Q 50/01; G06Q 30/0267; G06Q 30/0279

(57) ABSTRACT

Computer implemented systems and methods for volunteer service tracking, promotion and participation are described herein. In one embodiment, the system includes a plurality of user devices with user interfaces, a mobile telephone network server, a mobile telephone user database, a web application server, a participant database, and a project database coupled via a network. In operation, the mobile telephone network server transmits user information from the mobile telephone user database to the web application server, and facilitates communication among users of the client devices with the web application server, and the social network server transmits user profile data from the social network database to the web application server. In turn, the web application server communicates with the user devices via the network to transmit and receive information referable to a volunteer service project, including parameters associated therewith.

### TECHNICAL FIELD

The present invention relates generally to a computer implemented system for tracking volunteer activities, providing participants with opportunities to share information about their volunteer activities with their peers and to enter competitions with peers, and providing participants with the opportunity to earn credits for rewards from sponsors.

### BACKGROUND

Social networking sites allow users to upload and share photographs and notes with friends, generate personalized newsfeeds, and monitor and interact with the activities of users' friends, and to request and establish connections with other users on the social networking site by becoming friends within the user's social network, for example.

### SUMMARY OF THE INVENTION

With parenthetical reference to the corresponding parts, portions or surfaces of the disclosed embodiment, merely for the purposes of illustration and not by way of limitation, the present invention provides a mobile application for volunteer service tracking, promotion and participation. The system running the application includes a plurality of client devices (12A-N) with user interfaces (14A-N), a mobile telephone network server (19), a mobile telephone user database (11), a web application server (22), a participant database (26), and a project database (24) coupled via a network (16), according to one embodiment.

### BRIEF DESCRIPTION OF THE DRAWINGS

FIG. 1 is a block diagram of a plurality of client devices, a social network server, a mobile telephone network server, and a web application server coupled via a network according to one embodiment;

FIG. 2 depicts an example system for running a volunteer service project through a social-media based platform including a web application server coupled to a project database and participant database according to one embodiment;

FIG. 3A depicts an example of a social media user database storing a social media user's profile information and network contacts according to one embodiment;

FIG. 3B depicts an example of a participant database storing participant profile information and participant responses according to one embodiment;

FIG. 3C depicts an example of a project database storing organization profile information, project information, and project banners according to one embodiment;

FIG. 4 depicts a flow chart of a process of establishing a volunteer service project with a web application server according to one embodiment; and,

FIG. 5 depicts a flow chart illustrating a sample operation of the system.

In the drawings, preferred embodiments of the invention are illustrated by way of example. It is to be expressly understood that the description and drawings are only for the purpose of illustration and as an aid to understanding, and are not intended as a definition of the limits of the invention.

### DESCRIPTION OF THE PREFERRED EMBODIMENTS

At the outset, it should be clearly understood that like reference numerals are intended to identify the same structural elements, portions or surfaces consistently throughout the several drawing figures, as such elements, portions or surfaces may be further described or explained by the entire written specification, of which this detailed description is an integral part. Unless otherwise indicated, the drawings are intended to be read (e.g., cross-hatching, arrangement of parts, proportion, debris, etc.) together with the specification, and are to be considered a portion of the entire written description of this invention. As used in the following description, the terms “horizontal”, “vertical”, “left”, “right”, “up” and “down”, as well as adjectival and adverbial derivatives thereof, (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or of rotation, as appropriate.

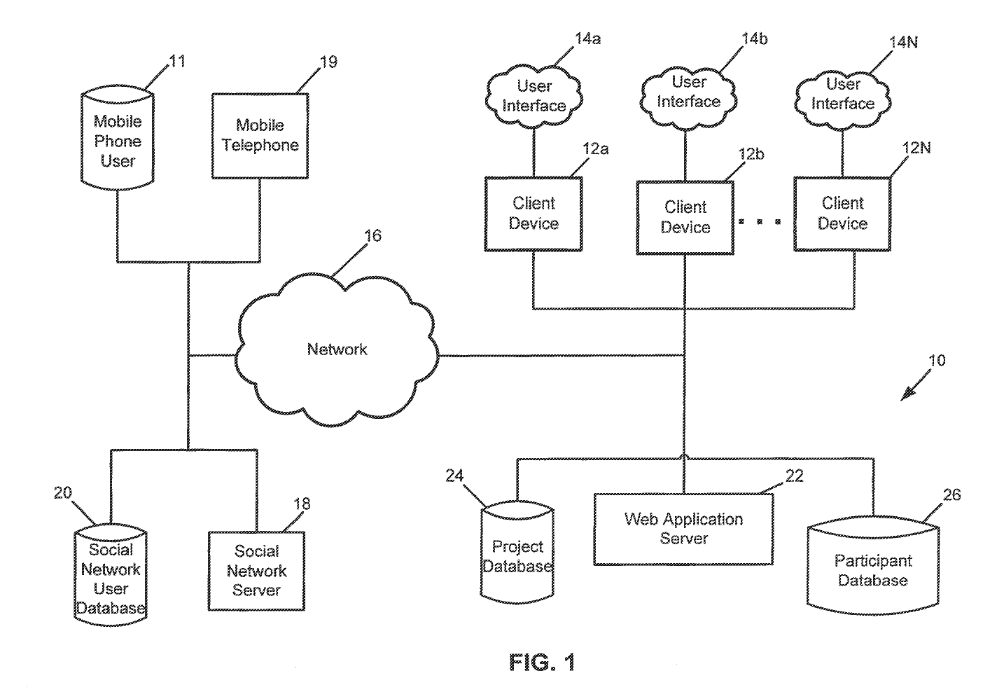

Referring now to the drawings, FIG. 1 illustrates a block diagram 10 of a plurality of client devices 12A-N with user interfaces 14A-N, a mobile telephone network server 19, a mobile telephone user database 11, a web application server 22, a participant database 26, and a project database 24 coupled via a network 16, according to one embodiment. More than one mobile telephone network server 19 and mobile telephone user database 11 may be coupled to the network 16. Also, more than one web application server 22, project database 24, and participant database 26 may be coupled to the network 16. Only one of each is shown in FIG. 1 for clarity.

The plurality of client devices 12A-N may be any system, device, and/or any combination of devices/systems that are able to establish a connection with another device, a server and/or other systems. The client devices 12A-N typically include display or other output functionalities to present data exchanged between the device and a user. For example, the client devices may be, but are not limited to, a server, a desktop computer, a computer cluster, a mobile computing device such as a notebook, a laptop computer, a handheld computer, a mobile phone, a smart phone, or a PDA. In particular, the Google Android software platform allows developers to write software applications to integrate third party applications with users of mobile devices, and Apple also allows third party applications developers access to the iPhone platform. In one embodiment, client devices 12A-N are each coupled to the network 16. In some embodiments, the client devices may be directly connected to one another.

The network 16, to which the client devices 12A-N are coupled, may be a telephonic network, an open network, such as the internet, or a private network, such as an intranet and/or the extranet. The network 16 may be any collection of distinct networks operating wholly or partially in conjunction to provide connectivity to the client devices and servers, and may appear as one or more networks to the serviced systems and devices. In one embodiment, communications may be achieved by a secure communications protocol, such as secure sockets layer (SSL), or transport layer security (TLS). In one embodiment, communications may be achieved via one or more wireless networks.

The client devices 12A-N may be coupled to the network, for example, the internet, via a dial-up connection, a digital subscriber loop (DSL, ADSL), cable modem, and/or other types of connection. Thus, the client devices 12A-N may communicate with remote servers (e.g., web server, host server, mail server, and instant messaging server) that provide access to user interfaces of the World Wide Web via a web browser, for example.

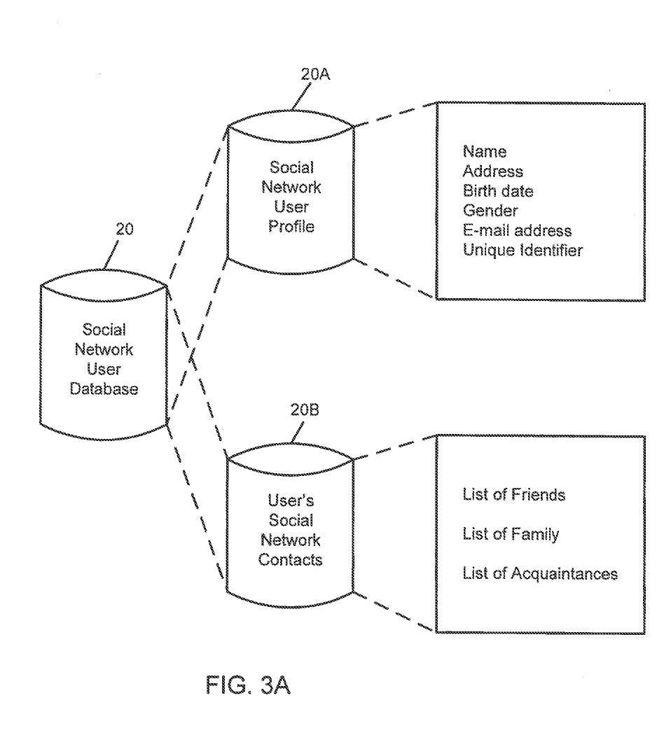

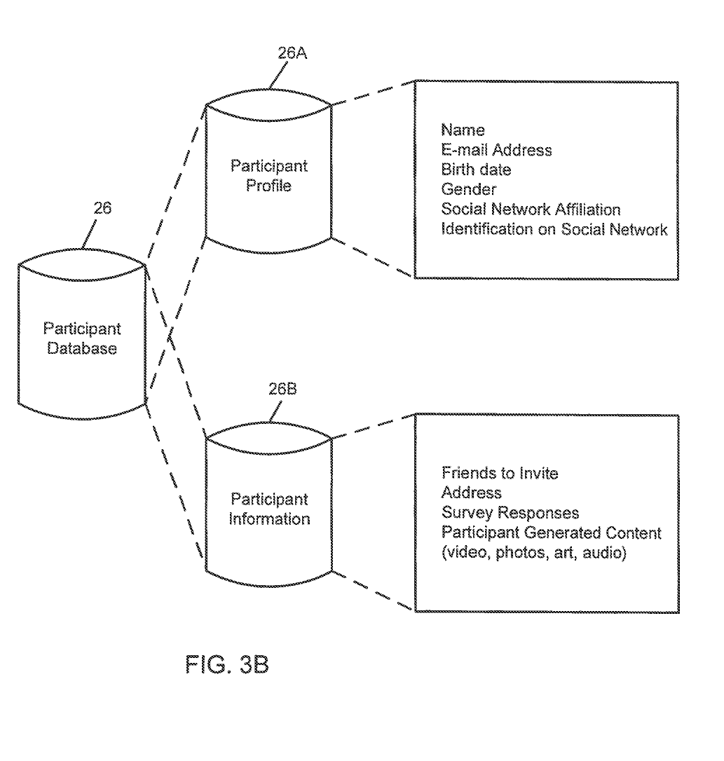

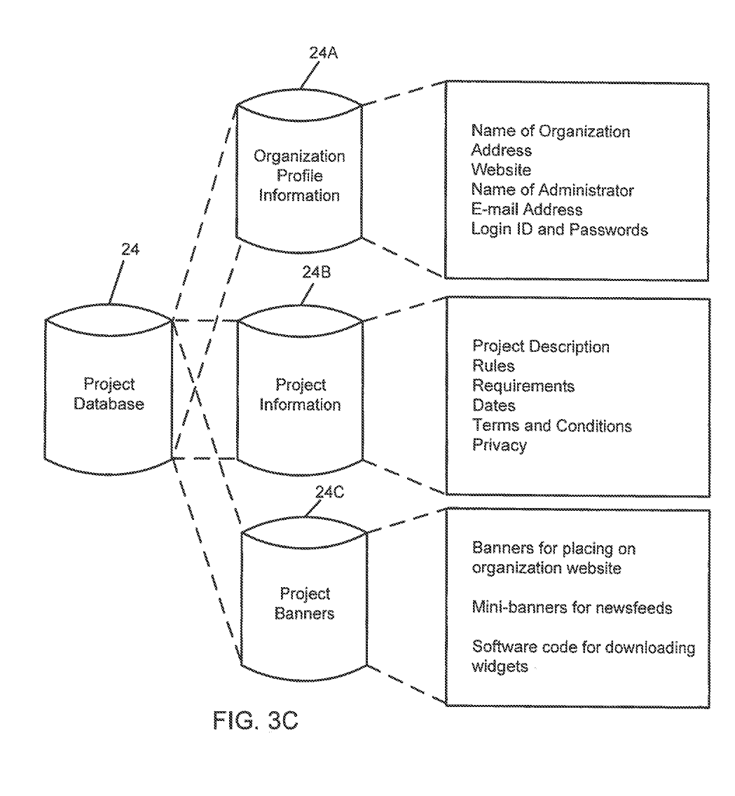

The user databases 11, 20, projects database 24, and participant database 26 may store information such as software, descriptive data, images, system information, drivers, and/or any other data item utilized by parts of the mobile telephone network server 19, and/or the web application server 22 for operation. User databases 11, 20, projects database 24, and participant database 26 may be managed by a database management system (DBMS), for example but not limited to, Oracle, DB2, Microsoft Access, Microsoft SQL Server, PostgreSQL, MySQL, FileMaker, etc. An example set of data to be stored in the participant database 26 and projects database 24 is further illustrated in FIGS. 3B and 3C.

The mobile telephone network server 19 may be any combination of software agents and/or hardware modules for establishing a mobile telephone network for users. The mobile telephone network server 19 may facilitate interaction and communication among users of the client devices 12A-N, with the web application server 22, or with other related applications and/or systems via the network 16. For example, the mobile telephone network server 19 may provide a platform for users of the client devices 12A-N who are members of the mobile telephone network to call or text message other users of the client devices 12A-N. In one embodiment, the mobile telephone network server 19 may support web browsing over a mobile telephone.

The social network server 18 may be any combination of software agents and/or hardware modules for establishing a social media-based platform for users. The social network server 18 may facilitate interaction and communication among users of the client devices 12A-N, with the web application server 22, or with other related applications and/or systems via the network 16. For example, the social network server 18 may provide a platform for users of the client devices 12A-N who are members of the social network to upload photos and notes to share with other users of client devices 12A-N who are also members of the same social network. In one embodiment, the social network server 18 may facilitate sharing of information about news and activities of members of the social network with other members designated as friends within the social network. The functionality of the social media-based platform may also be distributed across multiple servers disposed across the network 16.

The social network server 18 is, in some embodiments, able to store and retrieve data from the social network user database 20. In some embodiments, the social network server 18 is able to provide data from the social network user database 20 to another authenticated server, such as the web application server 22 via the network 16. Multiple social network servers 18 may be coupled to the network 16, with one or more social network servers 18 providing services for distinct social networks.

The mobile telephone network server 19 is, in some embodiments, able to store and retrieve data from the mobile telephone user database 111. In some embodiments, the mobile telephone network server 19 is able to provide data from the mobile telephone user database 20 to another authenticated server, such as the web application server 22 via the network 16. Multiple mobile telephone network servers 19 may be coupled to the network 16, with one or more mobile telephone network servers 19 providing services for distinct mobile telephone networks.

The web application server 22 may be any combination of software agents and/or hardware modules for generating a customized online volunteer service project to be used with a widget, and/or webpage, and/or application to be integrated with one or more social media-based platforms. The application is used with a social media-based platform and allows participants to enter the volunteer service project form from within the social-media based platform.

Alternatively or additionally, the web application server 22 may generate a customized mobile telephone volunteer service project application for use in conjunction with a mobile telephone network platform and/or with mobile telephone devices. The mobile telephone application permits a mobile telephone user to view and enter volunteer service projects generated by the web application server 22 without having to enter the Internet browser on the mobile telephone to enter the promotion.

The web application server 22 is, in some embodiments, able to communicate with client devices 12A-N via the network 16 to receive detailed information about the volunteer service project from the service organization's representative through project administration software. The detailed information may be stored and retrieved in the project database 24 via the network 16.

After a customized volunteer service project has been integrated with a project application within a participating social media-based platform and/or a widget and/or a webpage, the web application server 22 may, in one embodiment, receive registration forms or project entry data from participants. In one embodiment, a participant may interact with the volunteer service project or enter the service project without submitting a registration form. In one embodiment, the web application server 22 is able to communicate with the social network server 18 via the network 16 to receive information about a participant from the participant's social media profile. The registration form data and the information from the participant's social media profile may be stored, subject to a social network's privacy and third party developer guidelines, in the participant database 26 via the network 16 for later retrieval and analysis.

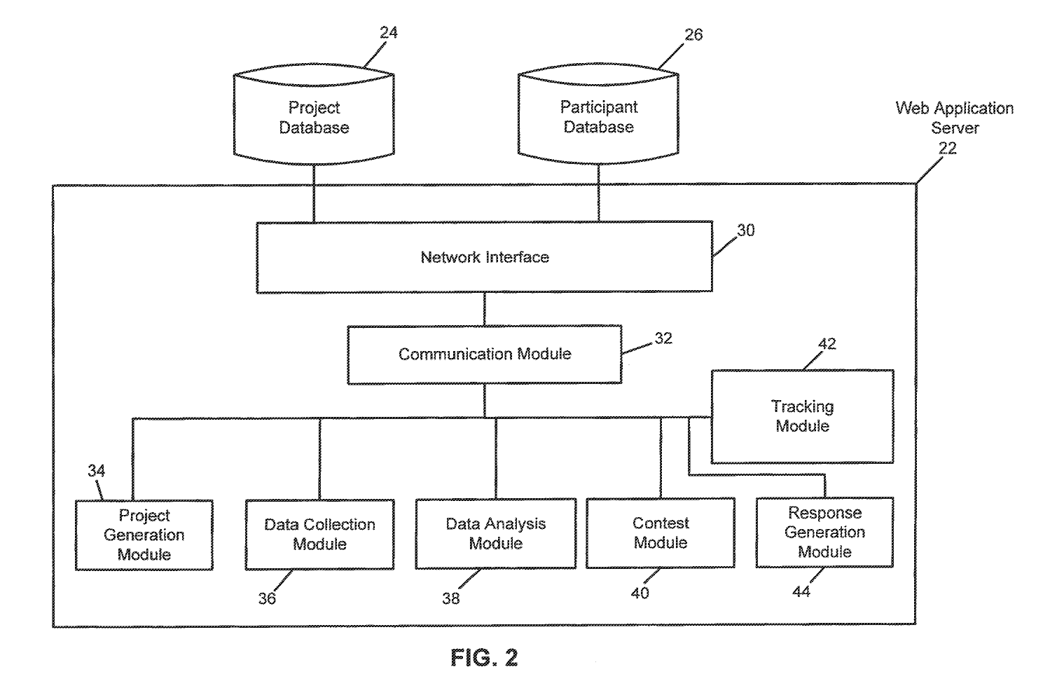

FIG. 2 is a block diagram illustrating a system for providing a customized online volunteer service project through the project administration software and integrating the online volunteer service project with one or more social-media-based platforms and/or mobile telephone network platforms. The system may include a web application server 22 coupled to a project database 24 and/or a participant database 26, according to one embodiment.

In the example of FIG. 2, the web application server 22 includes a network interface 30, a firewall (not shown), a communications module 32, a project generation module 34, a data collection module 36, a data analysis module 38, a contest module 40, a tracking module 42 and a reporting module 44. Additional modules or fewer modules may be included. The web application server 22 may be communicatively coupled to the project database 24, and/or the participant database 26 as illustrated in FIG. 2. In some embodiments, the project database 24 and/or the participant database 26 are partially or entirely internal to the web application server 22.

In the example of FIG. 2, the network interface 30 may be one or more networking devices that enable the web application server 22 to mediate data in a network with an entity that is external to the server, through any communications protocol supported by the server and the external entity. The network interface 30 may include, but is not limited to, one or more of a network adaptor card, wireless network interface card, router, access point, wireless router, switch, multilayer switch, protocol converter, gateway, bridge, bridge router, hub, digital media receiver, and/or repeater.

A firewall may, in some embodiments, be included to govern and/or manage permission to access data in a computer network, such as promotions database 24 and/or participant database 26, and track varying levels of trust between different machines and/or applications. The firewall may be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall may additionally manage and/or have access to an access control list which details permissions including for example, the access and operation rights of an object by an individual, a machine, and/or an application, and the circumstances under which the permission rights stand.

Other network security functions may be performed or included in the functions of the firewall including, but not limited to, intrusion-prevention, intrusion detection, and personal firewalls. In some embodiments, the functionalities of the network interface 30 and the firewall are partially or wholly combined and the functions of which may be implemented in any combination of software and/or hardware, in part or in whole.

In the example of FIG. 2, the web application server 22 includes the communications module 32 or a combination of communications modules communicatively coupled to the network interface 30 to manage a one-way, two-way, and/or multi-way communication sessions over a plurality of communications protocols. In one embodiment, the communications module 32 receives data, information, commands, requests, and/or text-based messages over a network. In one embodiment, the communications module 32 receives communications from a network (e.g., internet, wired and/or wireless network) initiated via a web-interface.

Since the communications module 32 is typically compatible with receiving and/or interpreting data originating from various communication protocols, the communications module 32 is able to establish parallel and/or serial communication sessions with users of remote client devices for data and command exchange (e.g., user information and/or user content).

In addition, the communications module 32 can manage log-on requests received from one or more users connecting to the web application server 22 including, but not limited to, generating a new project, entering a project, reviewing participant data for a project, selecting a winner for a contest related to a volunteer service project, and/or providing information to be included with a notification and/or newsletter to be sent to participants of a project. In some instances, authenticated sessions are managed by the communications module 32 for user logon processes.

For example, the system may utilize a username/email and password identification method for authorizing access. The communications module 32 may gather data to determine if a user is authorized to access the system and if so, securely logs the user into the system. In other embodiments, other forms of identity authentication, such as security cards and/or digital certificates may be utilized. A user may be able to specify and/or obtain a logon ID after subscribing or registering.

The communications module 32 may also establish communication sessions with a social networking server 18 to transmit customized promotion banners and other information for displaying information about a volunteer service project on a webpage within a social networking site or to transmit or receive information about participants.

One embodiment of web application server 22 includes a project generation module 34. The project generation module 34 may be any combination of software agents and/or hardware components able to request and receive detailed information from an organization or company about the volunteer service project to be generated. Based upon the received information, the project generation module 34 generates a customized online promotion to be used with a widget and/or webpage and/or promotion application integrated with one or more social media-based platforms. In one embodiment, a customized business version of the project application is provided to the administrator of an organization running a volunteer service project for adding to the organization's social media network page in order to display a promotion banner on the organization's social media network page. In one embodiment, the project application can be used to display a promotion banner on the organization's social network page because the project application is able to distinguish between downloads to a participant social network page and an organization social network page. In one embodiment, the organization's social network page may be run from a business page of the social network, if the social network provides business pages for organizations.

In one embodiment, a line of software code may also be provided by the project generation module 34 for pasting into the organization's webpage or other webpages external to participating social media-based platforms. The software code downloads a widget onto the webpage that displays information for advertising the volunteer service project and the organization. The widget integrates the volunteer service project with the viral features of the participating social media-based platforms and accesses the data contained in a participant's social media-based platform profile without requiring participants to migrate away from the widget. The widget may include, but is not limited to, clickable banners, clickable text, and clickable links. Upon clicking on any of the clickable objects, the participant may be provided a volunteer service project registration form or some other way to interact with the project in order to enter the volunteer service project.

In one embodiment the organization may be provided with the option to display a clickable banner, button or link on the website(s) instead of a widget. Clicking on the banner, button or link would take a participant to a webpage containing the project registration form.

In one embodiment, the project generation module 34 provides a listing page within each participating social media-based platform of all currently active volunteer service projects accessible from a webpage within the social media-based platform. In one embodiment, the listing page only includes projects that have recently been entered by the participant's social network friends. In one embodiment, the listing page only includes projects that relate to the interests and/or demographic of the participant as determined by the participant's social network profile data. In one embodiment, the participant can pre-define which types of projects he wishes to appear on the listing page. In one embodiment, a listing page of all currently active projects is provided on a webpage or webpages external to the participating social media-based platforms

In one embodiment, the project generation module 34 may provide a project application to a participant for adding to the participant's social network profile, if the participant has not previously registered for a project through the project application.

In one embodiment, an online promotion for use with mobile telephones on a mobile telephone network platform may allow a mobile device user to access the volunteer service project in multiple ways. The mobile device user may download to his mobile device a mobile phone project application designed for use with mobile devices, such as an iPhone. Alternatively, the mobile device user may access the device's browser and enter a volunteer service project through the social network of his choice or the website of the organization offering the project or another website external to the participating social media-based platforms. In both situations, the viral features of the social network or networks associated with the project are available to increase awareness of the project and the organization.

In one embodiment, the mobile telephone promotion application allows location-specific projects to be offered. For example, if a mobile phone user is in proximity to a business running a volunteer service project, the user receives an alert inviting the user to register for the project.

In one embodiment, the mobile telephone project application may access global positioning system (GPS) data provided by a participant's mobile telephone. The GPS data can be used in conjunction with an organization's volunteer service project. For example, the GPS data may be used to determine the eligibility of a participant for a project. For example, if a participant is located within a predetermined area within a certain time window, the participant would be eligible for a project. Alternatively or additionally, the GPS data can be used to evaluate a participant, for example, measuring how quickly a participant completes a project that requires participants to visit certain points in a city or region. In one embodiment, the GPS data may be used in the generation of activity feeds (such as newsfeeds and minifeeds) that display information about participants' interactions with projects that are being run using the mobile telephone project application. For example, when a participant enters a site where a volunteer service project is being conducted, a newsfeed may be generated in the participating social network based platforms. In one embodiment, the GPS data can also be used by the mobile telephone promotion application to enable a participant to interact with the project.

In one embodiment, the project generation module 34 provides for establishing competitions between participants where participants can earn points/rewards based on their efforts on service projects. The participants may earn badges, move up levels, and compete with their friends to have the largest impact in their communities. The competitions are social media empowered through sharing among online channels and friends through the interaction with the social network server 18 via the network 16 as described in detail herein.

In one embodiment, the project generation module 34 calculates credits e.g., “clean credits” for an environmentally based service project. The “clean credit system” assigns a base score to various volunteer activities in the environmental sector. This score is a measured impact based on environmental data for the country.

In one embodiment, “clean credits” or CLEANCREDS may comprise a currency that is earned from volunteer service and community impact. Contrary to traditional loyalty and rewards programs that provide value in return for monetary purchases, the participants in volunteer service projects can earn rewards based on the volunteer hours they donate to their community and the level of impact. The rewards may take the form of gift cards/brand credits and or prizes such as electronics, mentorship opportunities or the like. Participating corporate sponsors may also provide discounts or other rewards to be distributed through the system.

One embodiment of the web application server 22 includes a data collection module 36. The data collection module 36 may be any combination of software agents and/or hardware components able to generate project registration forms for a participant and to receive completed project registration forms from participants, through the communications module 32. The project registration form may advertise the project and allow the participant to interact with the project by entering the project and/or providing required information prior to registering for the project.

In one embodiment, the data collection module 36 may provide a method to advertise the project and for the participant to interact with the project without the explicit use of project registration forms. For example, the data collection module 36 may collect data from participants through questions used in part of a quiz promotion.

In one embodiment, a participant may be advised by the data collection module 36 that by downloading the project application, the participant grants the web application server 22 permission to access the participant's unique identifier within the social network or the mobile telephone network, and also accepts the terms of entering a project. Access to a participant's unique identifier enables the web application server 22 to send targeted information relating to the project or the organization running the project to the participant through the social network server 18. Terms for entering a project may include agreeing to receive unsolicited information, for example, a newsletter sent by either the web application server 22 or the organization running the project. Alternatively or additionally, the terms for entering a project may include the participant's permission for the organization running the project to use the information provided by the participant to promote other goods or services that may or may not be related to the underlying project or to promote other related business activities of the organization. In one embodiment, if an organization is promoting a third party organization's goods and/or services, the terms for entering a project may include the participant's permission for the third party organization to use information provided by the participant for related business activities.

One embodiment of the web application server 22 includes a data analysis module 38. The data analysis module 38 may be any combination of software agents and/or hardware components able to analyze the data collected from participants in a particular project through the participants' project registration forms or other forms of data resulting from participants' interaction with the project. The data analysis module 38 may generate data that include, but are not limited to, date and time of registration, unique identifiers of participants, participant information, such as email address or date of birth, and a demographic breakdown of participants by age, gender, zip code, the average age of participants, etc. The data analysis module 38 may also generate information about the types of contests, prizes, or rewards that generated the greatest number of registrations for service projects, for example sporting event tickets. In one embodiment, the data analysis module 38 may provide names and/or unique identifiers of participants who invited the largest number of friends to enter the service project and/or names of participants whose friend invites ultimately resulted in the greatest total number of people who registered for the project. In one embodiment, the data may be numerical, graphical, or both.

The data analysis module 38, through communications with the communications module 32, may make the data available to an organization running the project at a particular secured website and may also provide the analyzed data in a downloadable format, for example in an Excel spreadsheet. Alternatively or additionally, the data may be sent to the organization in an email through the communications module 32.

In one embodiment, the data analysis module 38 may verify one or more of the data provided by participants in the registration form or during interaction with the project. In one non-limiting example, a participant may be required to be at least 18 years old and/or from a specific country, state or location before participating in a particular project. Thus, the participant's age and/or geography may be verified prior to permitting the participant to enter the project. In another non-limiting example, a participant's email address or other entry information may be verified before permitting the participant to enter the project or if a participant is selected as a winner, the participant's email address or other entry information may be confirmed prior to awarding of the prize.

One embodiment of the web application server 22 includes a contest module 40. The contest module 40 may be any combination of software agents and/or hardware components able to calculate the winner of contests, as specified by the project rules. Alternatively, the contest module 40 may select a winner according to other criteria specified by the rules of the project. The contest module 40 may not always be used by an organization to select a winner. The organization may choose to select its own winner, for example, based upon subjective criteria such as the participant that most impressed the staff of the organization hosting the project. If the organization selects the winner, the organization may submit the name of the winner or winners to the contest module 40. Alternatively, submission of entries that are subjectively evaluated may be thrown open to judging by members of the social network. For example, each member of the social network may be permitted to vote a maximum number of times during the project or a maximum number of times per day for a preferred participant, and the winning participant is the one that garners the greatest total number of votes at the close of the project. By integrating user voting within the social media-based platform, viral features, such as newsfeeds and minifeeds, further spread the word about the project.

In another example, members of a social network could vote for their favorite volunteer service project, and the act of voting would generate a newsfeed that included, but is not limited to, the name of the person, the name of the service project that the person voted for, and the name of the organization sponsoring the project. In addition, the a video from the project may be embedded in the newsfeed.

Once a winner is selected, whether by the contest module 40, by the organization running the project, by voting, or by another method, the winner selection and notification module 40 may, through the communications module 32, notify all the participants who entered the project of the identity of the winner or winners. Notification may be by email or through custom messages directed to the social network inbox of all participants.

In one embodiment the web application server 22 includes a tracking module 42. The tracking module 42 may be any combination of software agents and/or hardware components able to receive input from a wireless tracking system such as a QR code reader on the site of the volunteer service project. The volunteer tracking and verification of actions may be based on QR codes or the like. The tracking module 42 calculates the time spent on a project and converts the hours into a measure of the impact that the service had on the community. In the case of environmental projects, environmental data for the country is used to calculate a “clean credit” based on the number of hours and the environmental data related to the activity and its impact on the environment. The tracking module 42 allows organizations to obtain tentative sign ups/numbers of volunteers and participants in their programs. The tracking module 42 allows for tracking volunteer turnout and analyze registration numbers versus actual turnout.

In one embodiment, the web application server 22 includes a reporting module 44 that may be any combination of software agents and/or hardware components able to generate reports with all volunteer activities including time spent on the activities, credits related to the impact of the activities, and volunteer hours per challenge. The reporting module 44 provides records that can be printed by a participant and submitted to their school for graduation volunteer hour requirements. These records are automatically verified by the host organizations through the system. In another aspect of the reporting module 44, the module 44 may receive feedback, reviews or comments from the participants upon check out/completion of the volunteer activity and generate a report for the organization based on this data.

FIG. 3A depicts a block diagram 50 illustrating an example of a social network user database 20 that stores social network user profile information 20A and the user's social network contact information 20B, according to one embodiment.

In the example of FIG. 3A, the social network user profile database 20A can store user profile data, including descriptive data of personal information such as, but not limited to, a first name and last name of the user, a valid email address, a unique user identifier within the social network, birth date, gender, occupation, etc. User profile data may further include interest information, which may include, but is not limited to, activities, hobbies, photos, etc. In one embodiment, the social network server 18 may store the information in the social network user database 20, and the web application server 22 may be permitted to access information in the social network user database 20 if the user grants permission. The database 20 may also store a user's social network contacts, for example, in database 20B. A user's social network contacts may be provided via one or more software agents and/or hardware modules coupled to the database 20B. For example, a user may invite a member of the social network to become a friend, and the invited member may become listed as such in the user's list of social network contacts if the invited member agrees.

A mobile telephone user database 11 for a mobile telephone network stores information similar to that of the social network user profile 20A portion of the social network user database 20, such as name, address, and mobile telephone number.

FIG. 3B depicts a block diagram 60 illustrating an example of a participant database 26 that stores participant profile information 26A and a participant's survey responses 26B, according to one embodiment.

In the example of FIG. 3B, a participant's profile information is stored in database 26A. Participant profile information includes descriptive data of personal information such as, but not limited to, a first name and last name of the user, a valid email address, birth date, gender, zip code, one or more social network affiliations and/or mobile telephone network affiliation, and a unique identifier on the one or more social networks and/or mobile telephone network the participant is affiliated with, etc.

The database 26 may also store a participant's responses to surveys and/or requests to invite friends, for example, in database 26B. A prerequisite to being entered in a volunteer service project may be for a user to complete a survey provided by the administrator of the project. Survey questions may include, but are not limited to, providing a name, an email address, demographic information, an address for receiving free samples and/or promotion materials and preference for joining a mailing list. In one embodiment, survey questions may include the option of electing to join one or more groups associated with the one or more social media-based platforms and the organization or a third party organization. For example, a participant may be given the opportunity to click a button or a link in order to become a fan of the organization's Facebook page, and the organization is then permitted to send messages via the Facebook platform to this participant so long as the participant remains a fan. In one embodiment, clicking on a link or a button or checking a box to elect to become a member of a group associated with an organization will automatically result in the participant becoming a member. Alternatively, clicking on a link or button or checking a box to elect to become a member of a group associated with an organization will trigger a pop-up window or a new browser window to open where the participant can take action to become a member of a group. Upon submission of a service project registration form, the participant is shown a webpage listing the names of the participant's social network friends, and he can select friends to invite to enter the project. An organization may provide an incentive to participants for inviting friends by, for example, increasing the participant's chances of winning for each friend that is invited or for each invited friend that subsequently enters the volunteer service project.

FIG. 3C depicts a block diagram 70 illustrating an example of a project database 24 that receives project information, according to one embodiment.

In the example of FIG. 3C, the profile information for an organization submitting a promotion is stored in database 24A. Organization profile information includes, but is not limited to, the name of the organization, address of the organization, a website address for the organization, names for one or more administrators within the organization, an email address for one of the administrators of the promotion, login identification, and passwords.

The project database 24 may also store promotion information in database 24B. Project information may include, but is not limited to, descriptions of the project, value of the measured impact of the project, requirements to enter the project, survey questions, the active dates for the project, terms and conditions, and the privacy policy of the organization with respect to information collected from participants.

The project database 24 may also store banners and widgets associated with a project in database 24C. Types of banners include, but are not limited to, banners for placing on an organization's website to advertise the organization's project, interactive widgets, mini-banners displayed in newsfeeds generated by the social network server 18 that advertise the project, and banners for displaying to a participant after the participant submits his registration to the project. In one embodiment, banners may be any size including, but not limited to, standard banner sizes, oriented horizontally, or oriented vertically.

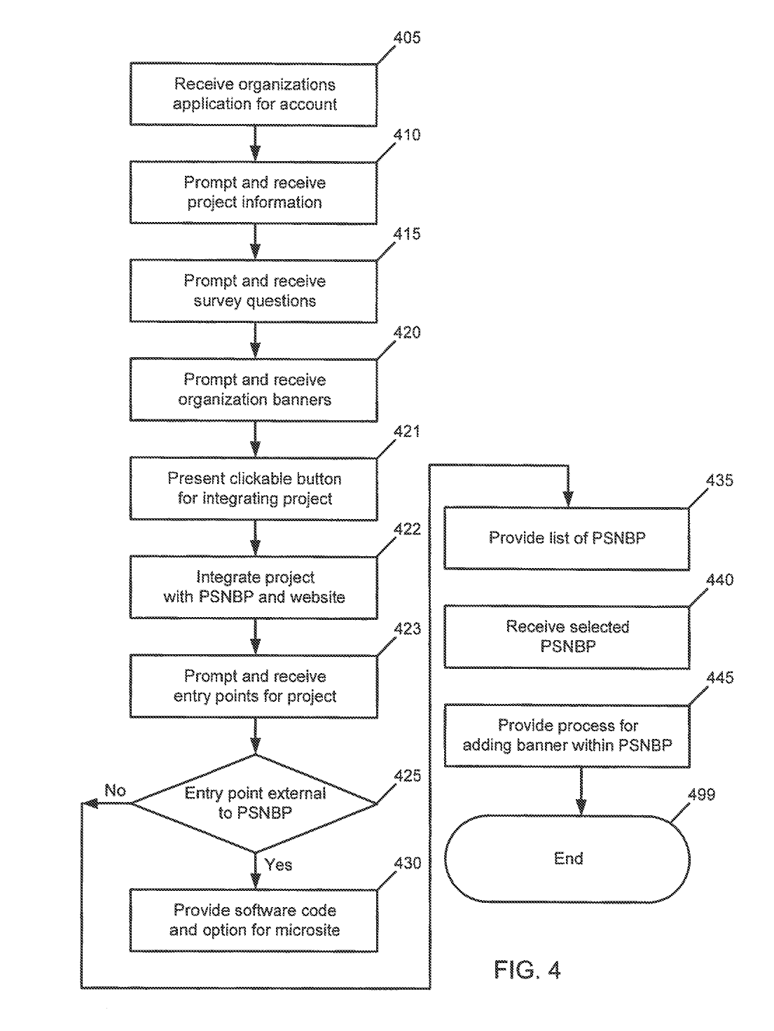

FIG. 4 depicts a flow diagram 400 illustrating an example process of establishing a volunteer service project with the web application server, according to one embodiment. Prior to permitting a company or organization to solicit participation in a volunteer project, the company or organization must first create an account with the web application server by transmitting account information to the system, preferably through a website, but mailed-in or faxed applications may also be used for creating an account on the system. The system receives the account information at block 405. Account information may include, but is not limited to, the organization's name, people permitted access to the company account, a billing address and billing information, such as a credit card number or billing authorization information. The organization is either assigned a login name and password, or the organization's representative may choose them. By providing the correct login information for an organization, the organization's representative is permitted to access the information for each project that the organization has created. After creating an account, at block 410 the organization's representative is prompted online by project administration software for information to set up the organization's project. A project may include, but is not limited to, environmental or social service projects.

After submission of the promotion information, at block 415 the organization's representative is prompted to define survey questions and/or text to be included in a customized registration form to be presented to a potential participant. Survey questions may include, but are not limited to, name, address, email address, interests, hobbies, vocation, etc. In one embodiment, questions include data used by an organization for marketing, branding, and/or future product line decisions. The system receives this information at block 415.

At block 420, the company is prompted to upload to the system a customized banner(s) or other design work for the project. Alternatively, template banner designs may be offered to the company for selection. Banners may be used to advertise the project and/or the brand of the organization sponsoring the project. Several types of banners may be uploaded, including but not limited to, a banner to place on the organization's social network webpage or company webpage, on other webpages within or external to a participating social media-based platform, or on a promotion widget on webpages within or external to participating social media-based platforms to advertise the project; mini-banners that may be displayed with newsfeeds, minifeeds and other similar user activity display features that are automatically generated when a user registers for a volunteer service project. Banners are clickable and may direct a participant to a project registration form or other entry point for interacting with a project. Alternatively, banners displayed after the participant has entered the project may direct the participant back to the organization's website or social network page. The system receives the banners and/or banner selections from the organization at block 420.

At block 421, the organization is presented with a clickable button for integrating its project with the project application in the participating social media-based platforms. Clicking this button will result in the integration of the project with the project application in all participating social media-based platforms (PSNBP) and the organization's own website at block 422. In fact, participants may click a different button for each social network that they want their project campaign to display on. Participating social media-based platforms are those social media-based platforms that are willing to support the project application and for which software is available to integrate the project application with the particular social media-based platform. Examples of online social media-based platforms that may participate include Facebook™, MySpace™, Bebo™, Orkut™, and Friendster™. Integrating a project with the project application within a participating social media-based platform enables participants to enter and interact with the project within a social network upon clicking a link to the project, such as found in a newsfeed or friend invite, for example. It should be noted that the organization does not need to maintain a webpage on a particular social media-based platform in order to have the project integrated with that platform. In one embodiment, integrating a project enables the project to be integrated with the viral features of a social network. In one embodiment, it enables the project to be included in the project listings page which is provided by the project application in each of the participating social media-based platforms and displays all projects currently integrated with the project application. In one embodiment, the project applications' listing page of a given social media-based platform is presented to a project participant after completion of the registration process for a project so that the participant may find other projects of interest to participate in.

In one embodiment, an organization can choose which participating social media-based platforms they would like to integrate their project with rather than automatically having their project integrated with all participating social media-based platforms.

At block 423, the organization is prompted to select where it would like to locate the entry point or entry points for its project. It can choose to locate the entry point(s) on one or more webpages external to the participating social media-based platforms or on one or more webpages within the participating social networks. The system receives the entry point information from the organization at block 423.

When the chosen entry point is a webpage external to the participating social media-based platforms, a participant interacts with a widget that advertises the project on the website(s). The participant clicks on the widget to register for the project, and the widget displays the project registration form. The widget integrates the project with the viral features of the participating social media-based platforms and accesses the data contained in a participant's social media-based platform profile without requiring participants to migrate away from the widget. In one embodiment, clicking on the widget enables the participant to interact with the project (e.g. play a game, enter a quiz, upload a video) before the participant is required to complete the registration form. In one embodiment the participant can interact with the project without completing a registration form. Upon completing the entry form or the project registration process through the widget, the participant is directed to invite friends to the project by using one of two methods. The participant may select friends from his social network friends list which is connected to the widget via services such as Google™'s FriendConnect™, Facebook™'s FacebookConnect™, MySpace™'s DataAvailability™ project and other similar services that enable third-party applications or websites external to social networks to access a user's data and friends list contained within social networks, and to transmit users' activity information back to the newsfeeds, minifeeds and other such activity feeds contained within social networks. Alternatively or additionally, the participant may type in friends' email addresses or select friends from his email address book which the participant can download into the widget from such email service providers as Gmail™, Hotmail™ and Yahoo Mail™.

In one embodiment the participant interacts with the project via an interactive webpage or webpages instead of a widget. The interactive webpage or webpages provide an entry form for the project and enable the participant to interact with the project. By connecting with services such as Google™'s FriendConnect™, Facebook™'s FacebookConnect™, MySpace™'s DataAvailability™ project and other similar services, the interactive webpage or webpages integrate the project with the viral features of the participating social media-based platforms and access the data contained in a participant's social media-based platform profile without requiring participants to migrate away from the interactive webpage or webpages. In one embodiment, the participant may click on a banner, button, or link that takes the participant to the interactive webpage or webpages for registering and interacting with the project. In one embodiment, the banner, button, or link may be located on an organization's website which advertises the project; a participant who clicks on one of these objects will be taken to the interactive webpage or webpages where he can enter and/or interact with the project. In one embodiment, the interactive webpage or webpages may be hosted by the web application server 112.

In one embodiment, an organization may choose to use a webpage dedicated to the entry process for their project, rather than a widget, because the widget may not provide sufficient graphics or other text, as desired by the organization to advertise the project. In one embodiment, an organization may select the widget because of its compact size and ability to enable a participant to interact with and/or register for a project without the participant needing to migrate away from the webpage upon which the widget is displayed, for example, the organization's webpage.

When the chosen entry point is on the organization's social network webpage or other webpage within one of the participating social media-based platforms, a participant clicks on a banner, widget, or link that advertises the project on the particular webpage, and the participant is directed to add the project application to the participant's social network profile. Alternatively, the participant may click on a banner, a link in a newsfeed or minifeed, a link in a friend invitation, or any link to the project generated by a viral feature of the social media-based platform, and the participant will be directed to add the project application to the participant's social network profile. In one embodiment, the participant may click on the banner, widget, or link and directly register for the project without downloading the project application to his social network profile.

At decision block 425, the system determines if the organization has chosen to have an entry point to the project on a webpage external to the participating social media-based platforms. If the organization chooses to establish an entry point for the project on a webpage or webpages external to the participating social media-based platforms (block 425—Yes), at block 430, the system provides software code, such as HTML or Javascript code, that may be copied and pasted into a webpage or webpages. The organization is also provided the option of publishing its project via a microsite linked to the organization's webpage or webpages. For the first option, the software code displays a widget on the webpage(s); the widget advertises the promotion and enables a participant to interact with and register for the project, thus the widget functions as an entry point to the project. In one embodiment the organization can select from a variety of widget templates that offer different design, layout and color options. Each template has its own unique software code that the organization can copy and paste into a website(s) to display the widget. In one embodiment the organization may be provided with the option to display a clickable banner, button, or link on the webpage(s) instead of a widget. Clicking on the banner, button, or link would take a participant to a webpage containing the project registration form.

For the microsite option, the organization representative does not need to paste code into a webpage. The project administration software permits the representative to simply click on an appropriate button that triggers publication of the organization's microsite.

The process continues to block 435 where the system presents a list of the participating social media-based platforms with which the organization's project has been integrated. The system also provides links corresponding to these participating social media-based platforms to which the organization can, if it wishes, add a project banner/entry point to particular webpages within those participating social networks. The webpages may be those that the organization maintains within the selected social media-based platforms. Alternatively or additionally, the webpages may also be maintained by entities other than the organization that permit the organization to insert project banners/entry points. The system receives the selected social media-based platforms at block 440.

In one embodiment, regardless of whether the organization chooses to add a project banner/entry point to particular webpages within the participating social media-based platforms, the project application will list the organization's project on a project listing page, with a clickable link, within the participating social network based platforms. In one embodiment the organization's project will also be listed on a project listing webpage that is external to the participating social media-based platforms. Thus, a participant may easily find and register for the project without having to go to a particular organization's webpage.

At block 445, the system provides the organization with two options for integrating a project with a social media-based platform. For the first option, a banner is added to the webpages of the specified social media-based platforms. The details for publishing a banner on webpages within different social media-based platforms may vary. However, as an example, the process for publishing a project banner on the organization's Facebook™ webpage(s) will be described. Clicking on the Facebook™ link provided at block 435 takes the organization's representative to a Facebook™ page where the representative can click on a link to download the project application for publishing project banners within Facebook™ Because the application is downloaded to a business page on Facebook™, the project application recognizes that the user is an organization and provides customized features for business users. In one embodiment, the organization downloads a customized business version of the project application. The organization is then prompted to provide its log-in information supplied to the project administration software that it previously established at block 405. After inputting the log-in information, the organization is taken to a webpage where the organization's projects that are integrated with the project application in Facebook™ are listed. A banner publication button is displayed next to each project which, when clicked, will add the banner for that project to the organization's Facebook™ page(s). The process ends at block 499, and at this point the project is ready to be entered from the organization's social network page and/or a webpage external to the participating social networks. Alternatively, the start of the project may be delayed until a specific date received by the system at block 410.

For the second option, the organization can create a dedicated tab within the organization's social network page within which they can publish one or more projects, such as provided for by the social network Facebook™.

In one embodiment, a project banner may be added to a webpage within a participating social media-based platform that is not controlled by the organization running the project, if the controller of the webpage agrees. For the example Facebook™ platform, the controller of the webpage would download the project application from within Facebook™ first and then go through a similar process as described above for adding a banner for the project to the webpage.

In one embodiment, an organization may paste the software code for displaying a widget on one or more webpages within a participating social media-based platform if the platform permits pasting software code for widgets, for example the MySpace™ platform.

If the organization chooses to not publish the project on its own webpage or another webpage external to the social media-based platforms (block 425—No), the process continues at block 435 as described above.

In another embodiment, the system may provide challenge reminders and integrate dates for challenges/service projects directly into a participant's calendar on their mobile device such as a smart phone.

In another embodiment, the system may offer an exclusive challenge that may limit the number of participants or may be only offered to participants having exemplary volunteer records or that have achieved certain levels of volunteer service.

In another embodiment, the host organizations can automatically retrieve emergency contacts/profiles for participants registered for a project.

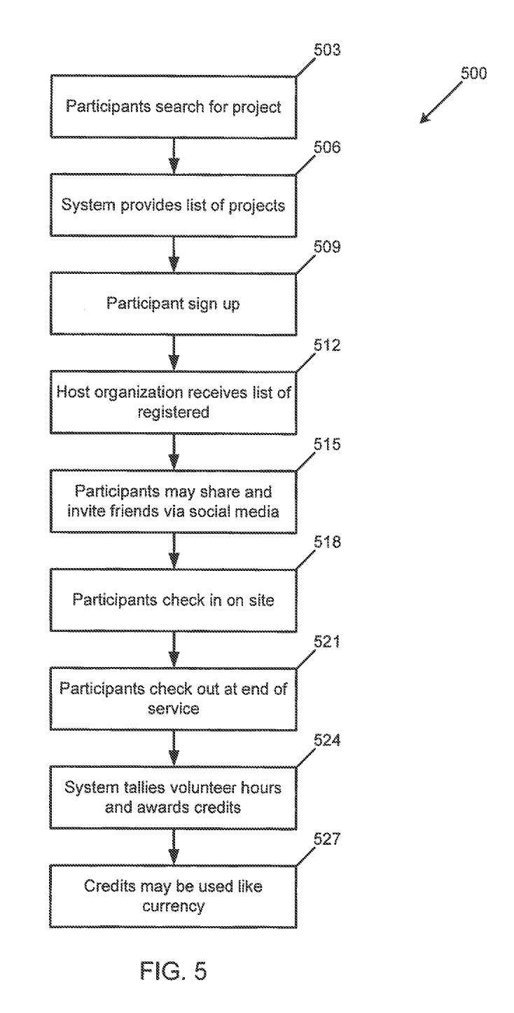

FIG. 5 depicts a flow diagram illustrating a sample operation of the system. In block 503 the participants may search for volunteer “challenges” a.k.a. volunteer activities/existing programs of local nonprofits or organizations. Through GPS technology in block 506 the system provides the participant with a list of volunteer service projects within geographic proximity of the participants current location. In block 509, the participant may sign up through an application on their client device or they may sign up through the system website. The challenge/volunteer service project is added to their profile. In block 512, the host organization receives a list of all of the participants that have registered for their program/activity. Once they have registered, in block 515 the participants can share via social media and their profile to invite friends to join them in the activity. In block 518, on the day of the event the participants automatically check in and in block 521 check out by scanning QR codes with their client devices at the project location. In block 524, after they have checked out of the activity, the system automatically tallies their volunteer hours and they receive “clean credit” scores based on the impact of the activity multiplied by their hours. In block 527, the “clean credits” or CLEANCREDS can be used like a currency to be redeemed for rewards from corporate sponsors.

The volunteer tracking and verification of actions may be based on QR codes or the like. In one embodiment, the participants have individual member ID's/QR codes and when they arrive at the event, the host organization scans their QR code. The challenge clock starts and the hours that the participant is volunteering are tracked. When the participant is finished, the host scans their QR code on their way out and the system stops the clock and the total volunteer hours are recorded.

In another embodiment, each challenge is assigned its own unique QR codes with one code for checking into an activity and the other code for checking out of the activity. Organizations can print their codes and place them in a location on site so that the participants can use their mobile devices to scan the check in code on the way into the activity and scan the check out code on the way out of the activity. Once the participant scans the check out code, the clock stops and the volunteer hours are recorded.

In another embodiment, the organization may automatically start and stop the clock at set times for all of the devices within the project site without recording individual times.

The present invention contemplates that many changes and modifications may be made. Therefore, while the presently-preferred form of the system has been shown and described, and several modifications and alternatives discussed, persons skilled in this art will readily appreciate that various additional changes and modifications may be made without departing from the spirit of the invention, as defined and differentiated by the following claims.

We claim:

1. A computer system coupled by a network for tracking volunteer service, promotion and participation of users, comprising:
a. a plurality of user devices;
b. a mobile telephone user database having stored thereon user information;
c. a mobile telephone network server for establishing a mobile telephone network for the users and retrieving user information from the mobile telephone user database;
d. a social network database having stored thereon user profile data;
e. a social network server for establishing a social media-based platform for the users to facilitate the sharing of user profile data between users;
f. a project database having stored thereon volunteer service project information;
g. a web application server for enabling the generation of a volunteer service project and integration of the volunteer service project with the social media-based platform,
wherein the mobile telephone network server transmits user information from the mobile telephone user database to the web application server, and facilitates communication among users of the client devices with the web application server, and the social network server transmits user profile data from the social network database to the web application server, and wherein the web application server communicates with the user devices via the network to transmit and receive information regarding the volunteer service project.

2. The system of claim 1, wherein the system further comprises multiple mobile network servers connected to the network.

3. The system of claim 1, wherein the volunteer service project information comprises descriptions of the project, value of the measured impact of the project, requirements to enter the project, survey questions, and the active dates for the project.

4. The system of claim 1 wherein the web application server communicates with the social network server via the network to receive information about users from the users' respective social media profiles.

5. A computer implemented system for providing a customized volunteer service project and integrating the volunteer service project with social-media platforms, comprising:
a. a social network database having stored thereon participant profile data;
b. a social network server for establishing a social media-based platform for the participants to facilitate the sharing of participant profile data between participants;
c. a web application server for enabling the generation of a volunteer service project and integration of the volunteer service project with the social media-based platform,
wherein the social network server transmits participant profile data from the social network database to the web application server, and wherein the web application server transmits and receives information regarding the volunteer service project.

6. The system of claim 5, wherein the web application server further comprises a communications module for receiving data, information, commands, requests, and/or text-based messages.

7. The system of claim 6, wherein the communications module also manages log-on requests received from one or more participants connecting to the web application server 22 including, for generating a new project, entering a project, reviewing participant data for a project, selecting a winner for a contest related to the volunteer service project, and/or providing information to project participants.

8. The system of claim 6, wherein the communications module also communicates with the social networking server to transmit information regarding the volunteer service project to a social networking site.

9. The system of claim 5, wherein the web application server further comprises a project generation module for requesting and receiving information from an organization regarding the volunteer service project to be generated.

10. The system of claim 9, wherein the project generation module further comprises a utility for establishing competitions between participants wherein participants can earn rewards based on their efforts on volunteer service projects.

11. The system of claim 5, wherein the web application server further comprises a reporting module for generating reports on participant volunteer activities and receiving participant feedback upon completion of the volunteer service project.

12. The system of claim 5, wherein the web application server further comprises a data analysis module for analyzing data collected from participants in a given volunteer service project.

13. The system of claim 5, wherein the web application server further comprises a contest module for selecting a winner according to criteria specified by the rules of the volunteer service project.

14. The system of claim 5, wherein the web application server further comprises a tracking module for receiving inputs from a wireless tracking system located at a volunteer project site and calculating participant time spent on a volunteer service project.

15. The system of claim 14, wherein the wireless tracking system is a QR code reader.

16. The system of claim 14, wherein the tracking module further comprises a utility for calculating a measure of the impact that the volunteer service project has on a community.
